(19) United States
(12) Patent Application Publication
(10) Pub. No.: US 2017/0349225 A1
(43) Pub. Date: Dec. 7, 2017

(54) A Cart and a Method for Transport and Storage of Items

(71) Applicant: BBHS A/S, Hedehusene (DK)

(72) Inventor: Lars THØGERSEN, Copenhagen S (DK)

(73) Assignee: BBHS A/S, Hedehusene (DK)

(21) Appl. No.: 15/540,168

(22) PCT Filed: Dec. 28, 2015
(86) PCT No.: PCT/EP2015/081286

§ 371 Date: Jun. 27, 2017

(30) Foreign Application Priority Data
Dec. 29, 2014 (EP) 14200439.9

(51) Int. Cl. B62D 53/00; B62D 63/06; B64F 1/36; B64F 1/32; B65G 67/02

(52) U.S. Cl. CPC B62D 53/005; B64F 1/368; B64F 1/32; B62D 63/06; B65G 67/02; B65G 2201/0264

(57) ABSTRACT

A cart for transport and storage of items, including odd-size or over-size luggage of airline passengers, comprises a chassis comprising a plurality of wheels, and a storage section comprising at least one shelf. A drawer is provided below the storage section, the drawer comprising a compartment, which is inaccessible when the drawer is in a closed state, in which the drawer is overlapped by a bottom portion of the storage section. The compartment is accessible when the drawer is in an open state, in which the drawer is extracted from and extends beyond the bottom portion of the storage section.

### TECHNICAL FIELD

The present invention relates to a cart for transport and storage of items, such as luggage items, parcels, food products or the like. The cart is particularly aimed at airport applications, for storing and transporting luggage items between luggage sorting or conveying apparatus and aircrafts.

### BACKGROUND OF THE INVENTION

Various systems are known for transporting, sorting and storing various items and goods, including luggage and parcel items. Such systems are usually tailored to meet specific requirements set by nature, size and weight of the items, as well as requirements regarding sorting, transport distances and speed of transportation.

One specific field of interest of the present application is the field of transportation and storage of luggage or parcel items in airports. In most airports, checked-in luggage is usually conveyed from a plurality of check-in counters to a central luggage conveying and/or sorting apparatus, at which each luggage item is sorted according to its destination. Such conveying and/or sorting apparatus normally comprises a plurality of discharge units, in each of which luggage items destined for a particular aircraft are accumulated. The luggage items are then manually loaded piece by piece onto carts or trolleys, by means of which the items are transported to the aircraft site. The carts or trolleys may be self-propelled, or they may be attachable to a propelling unit (or tractor), which may be arranged to pull a plurality of trolleys or carts coupled together to form a train. Likewise parcels being sorted are typically discharged from a sorter conveyor into a plurality of collecting stations, each of which is designated for a particular destination. From the collecting stations, the parcels are transported in containers, such as Unit Loading Devices (ULD), cages or bins to an aircraft site. Such containers, cages or bins are frequently loaded onto aircrafts.

Arriving luggage and arriving parcels at airports are typically conveyed from an aircraft site in similar carts, containers, cages or bins to a conveyor site, which conveys the items onto a sorter conveyor, if the items are in transit, or to a luggage reclaim belt or a parcel distribution facility if the items have arrived at their final destination airport. The items are unloaded piece by piece manually or in an assisted manner including lifting aids or tools.

International patent publication No. WO 2008/020084, upon which the pre-amble of claim 1 is based, discloses a cart for transport and storage of items comprising a plurality of inclined shelves arranged in rows and columns as a matrix. The cart can be coupled to an identical cart, and multiple coupled carts may thus form a train. Though the cart disclosed in WO 2008/020084 greatly improves luggage handling between airplane sites and airport conveyors, a need for handling of odd-size or oversize items has arisen.

### SUMMARY OF THE INVENTION

On the above background it is an object of embodiments of the invention to provide an improvement of the above cart, which is able to conveniently handle odd-size and oversize items. As the main storage compartment of the cart with the plurality of shelves seeks to standardize and automate baggage handling, a cross section size of the individual shelf is accommodating 90-95% percentile of all baggage. Now a need for handling the out of gauge of said shelves and genuine odd-size baggage handling has arisen.

In a first aspect, the invention provides a cart for transport and storage of items, comprising:
a chassis comprising a plurality of wheels;
a storage section comprising at least one shelf;
   characterised by:
   a drawer below the storage section, the drawer comprising a compartment which is inaccessible when the drawer is in a closed state, in which the drawer is overlapped by a bottom portion of the storage section, and wherein the compartment is accessible when the drawer is in an open state, in which the drawer is extracted from and extends beyond the bottom portion of the storage section.

In a second aspect, the invention provides a method for transport and storage of items by means of a cart comprising
a chassis comprising a plurality of wheels;
a storage section comprising at least one shelf;
a drawer below the storage section, the drawer comprising a compartment which is inaccessible when the drawer is in a closed state, in which the drawer is overlapped by a bottom portion of the storage section, and wherein the compartment is accessible when the drawer is in an open state, in which the drawer is extracted from and extends beyond the bottom portion of the storage section;
   said method comprising the steps of:
loading a first group of said items onto the at least one shelf of the storage section;
loading at least one further item into the compartment of the drawer when the drawer is in the open state, said at least one further item being sized and shaped so that it does not fit into the compartment when the drawer is in the closed state; and
transporting the items by means of said cart while the drawer remains in the open state.

Odd-size and over-size items which do not fit onto the shelves of the cart, or which are otherwise not suited for accommodation by the shelves, may be placed in the drawer, when the compartment is accessible, i.e. in the open state of the drawer. In the closed state of the drawer, it is preferably overlapped, most preferably completely overlapped, by the bottom portion of the storage section of the cart, so that the drawer does not occupy space or provide an obstacle when it is not being used. Hence, the drawer provides a space and structure for accommodating items when need, and when no such space and structure is needed, the drawer is conveniently stowed away underneath the storage section.

Generally, the storage section and the at least one shelf thereof may be sized and configured to accommodate items having a dimension or volume not exceeding a first maximum dimension or a first maximum volume, and the compartment may be sized and configured to accommodate odd-size items having a dimension or volume exceeding the first maximum dimension or the first maximum volume.

In one embodiment of the invention, the storage section comprises a plurality of shelves arranged in rows and columns to form a matrix of shelves.

As will have become apparent from the above description, the first group of items accommodated by the shelves of the cart may comprise air passenger luggage, and said at least one further item may comprise odd-size or oversized air passenger luggage. The cart of the present invention is in particular suited for transporting items, such as luggage items, from an aircraft to a luggage conveyor of an airport, or from a luggage sorting conveyor of the airport to the aircraft. Other fields of use are envisaged, such as for example uses for food items, such as dairy or bakery products, notably in the field of retail distribution of goods in warehouses, grocery stores or supermarkets.

In order to couple the cart to an identical one to form a train of carts, a connecting element may be provided at the cart, the connecting element having a free end which is configured to connect to the other cart. The connecting element preferably extends from the chassis of the cart below the drawer in the direction of extraction of the drawer, with the free end of the connecting element extending beyond the drawer when the drawer is fully extracted. The connecting element may hence couple to the next cart even when the drawer is open to allow the cart to be driven in a train of carts with the drawer in the open state. In an alternative embodiment, a front end of the cart may comprise a front connector, and the rear end of the cart may comprise a rear connector for connecting to the front connector or an identical cart, whereby the front connector and the rear connector together have a length exceeding the length of the drawer when extracted.

A structure may be provided for releasably locking the drawer in a selected one of a partly extracted position and a fully extracted position. In such embodiment, the connecting element may be configured to connect the cart to another, identical cart, for example by the connecting element extending beyond the drawer when the drawer in the partly extracted position. The connecting element and the drawer may be sized and configured such that the cart is not connectable to the other cart when the drawer is in the fully extracted position.

The length of the drawer, which may be as long as the cart or nearly as long as the cart may hence be fully utilized when the cart is the last one in a train of carts or is used as a stand-alone device, whereas the full length of the drawer does not occupy excessive space between neighbouring carts in a train of carts and hence does not unnecessarily limit the radius of curvature of the train.

In one embodiment of the invention, the bottom portion of the storage section of the cart comprises a planer bottom surface, which is inclined relative to horizontal, in which case the drawer preferably comprises correspondingly tapering side structures, so as to allow the drawer to be accommodated in a safe-spacing manner below the storage section.

The at least one shelf may preferably comprise a plurality of shelves arranged in rows and columns. Each of the shelves may be inclined relative to horizontal, so as to thereby define an upper end and a lower end, the upper end of each shelf being arranged at a loading end of the cart, and the lower end of each shelf being arranged at an unloading end of the cart. The shelves may be permanently inclined, or they may be inclinable from a non-inclined position to the inclined position. For example, the shelves may be brought into their inclined position for loading or unloading, e.g. at the aircraft site.

In one embodiment of the method according to the present invention, the at least one cart comprises at least two identical carts, each of which comprises:
structure for releasably locking the drawer in a selected one of a partly extracted position and a fully extracted position, and
a connecting element, the free end of which is configured to connect the cart to another cart, the connecting element extending from the chassis of the cart below the drawer in the direction of extraction of the drawer, wherein the free end of the connecting element is able to connect to another one of the carts when the drawer is in the partly extracted position, and wherein the free end of the connecting element is unable to connect to the other one of the carts when the drawer is in the fully extracted position; the method comprising the step of selectively:
transporting said at least one further item in the compartment of the drawer of a first one of the carts, when the drawer is in the partly extracted position, and while the first cart is coupled to a second one of the carts by means of the connecting element with the drawer of the first cart facing the second cart;
transporting said at least one further item in the compartment of the drawer of a first one of the carts, when the drawer is in the fully extracted position, and while
   the first cart is not coupled to the second one of the carts or
   the first cart is coupled to the second one of the carts by means of the connecting element with the drawer of the first cart facing away from the second cart.

The length of the drawer, which may be as long as the cart or nearly as long as the cart may hence be fully utilized when the cart is the last one in a train of carts of is used as a stand-alone device, whereas the full length of the drawer does not occupy excessive space between neighbouring carts in a train of carts and hence does not unnecessarily limit the full maneuverability of the train, including its radius of curvature.

In a third aspect, the invention provides a system comprising at least one cart and an accumulation unit for loading items on to the cart or for accepting items offloaded from the at least one cart, the at least one cart comprising:
a chassis comprising a plurality of wheels;
a storage section comprising at a plurality of shelves arranged in rows and/or columns to form a first matrix pattern;
   characterized in that
the accumulation unit comprises a plurality of shelves arranged in rows and/or columns forming a second matrix pattern, and in that
each one of the shelves the first and second matrix patterns forms a continuation of (i.e. lies approximately flush with) a mating one of the shelves of the other one of the first and second patterns when the at least one cart is in a predetermined parking position relative to the accumulation unit.

Thanks to the mating matrix structures of shelves of the cart and the accumulation unit, items may be loaded onto the at least one cart and offloaded therefrom in an automated manner, preferably without manual labour intervention. For offloading of items from the shelves of the cart, items may be offloaded under the action of gravity when the shelves are inclined, or they may be offloaded by movement of belts or other conveyor means on-board the cart. For loading of items onto the cart, the aforementioned on-board conveyor means may be applied, and/or conveyor means, such as belts, of the accumulation unit may bring about the required transfer of the items from the accumulation unit onto the shelves of the cart.

Embodiments of the accumulation unit comprising pluralities of shelves arranged in rows and columns, the accumulation unit may advantageously be used in sorting facilities for e.g. transport and accumulation of airport luggage, parcels or dairy products. The matrix structure formed by the arrangement of shelves in rows and columns provides a plurality of separated compartments on a single accumulation unit. This in turn allows a high number of items to be stored on a single cart in order to maximize utilization of the volume occupied by the storage section, while at the same time not mixing already sorted parcels and/or airport luggage.

Each of the shelves of the accumulation unit may comprise a conveyor, such as a gravity conveyor and/or a conveyor belt, roller belt or the like.

The at least one cart may, for example, include a cart as disclosed and claimed in international patent publication No. WO 2008/020084. In another embodiment, the at least one cart includes a cart according to the first aspect of the present invention.

### BRIEF DESCRIPTION OF THE DRAWINGS

Embodiments of the invention will now be further described with reference to the accompanying drawings, in which:

FIGS. 1-6 illustrate various embodiments, features and operating principles of a cart according to the invention;

FIG. 7 illustrates modular assembly of an embodiment of the cart according to the invention;

FIG. 8 illustrates various uses of and interface for embodiments of the cart according to the invention, and a system according to the third aspect of the invention.

### DETAILED DESCRIPTION OF THE DRAWINGS

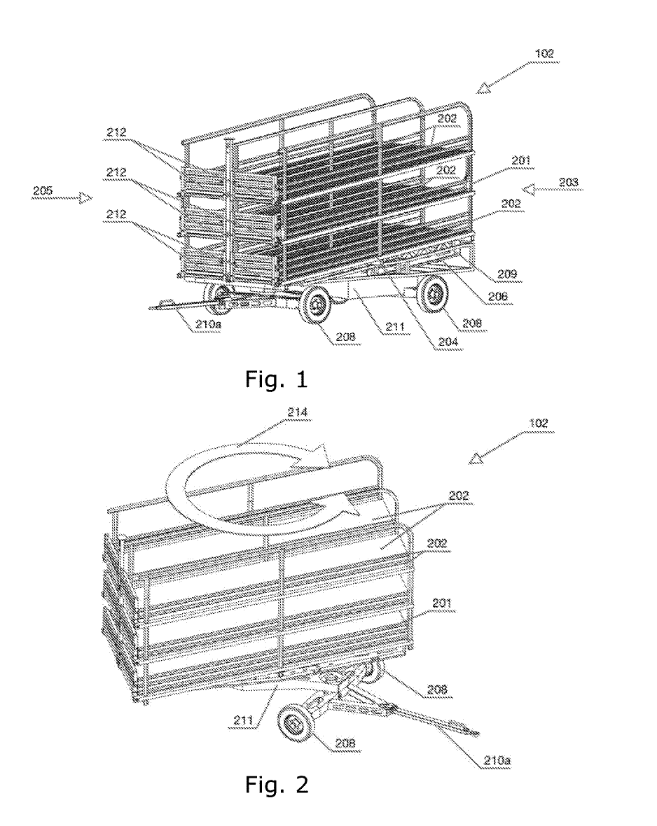

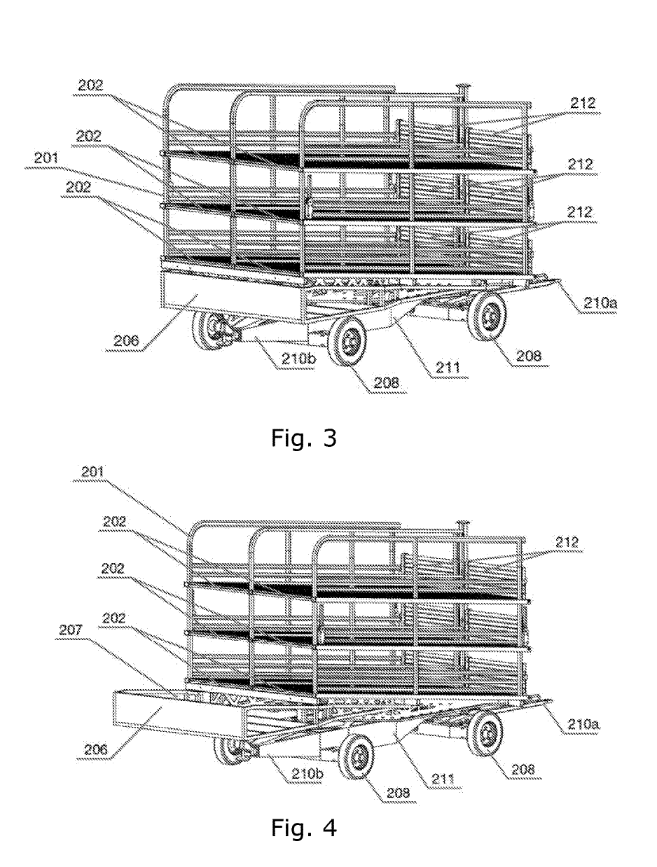

FIGS. 1-8 illustrate various embodiments of the cart 102 for use in the system 100 of the present invention. The cart 102 comprises a storage section 201 comprising a plurality of cart shelves 202, each of which is inclined relative to horizontal for automatically conveying items from an upper loading end 203 of the cart 102 towards a lower unloading end 205 thereof. The cart comprises a chassis 211 and a plurality of ground-engaging wheels 208, and a drawer 206 below the storage section 201. The drawer 206 comprises a compartment 207 (see FIG. 4) for accepting odd-size items when the drawer is in the open state as shown in FIG. 4. In the non-retracted, i.e. closed state of the drawer 206 shown in FIGS. 1-3, the compartment 207 is inaccessible, and the drawer is overlapped by a bottom portion 204 of the storage section 201. In the retracted, i.e. open configuration shown in FIG. 4, the compartment is accessible.

In use, the cart may be selectively operated with the drawer 206 in its open or in its closed state. Typically, ordinary items, such as suitcases and ordinary bags are loaded onto the shelves 202. If no odd-size or over-size items are to be transferred by the cart 102, it is normally operated with the drawer 206 in the closed state. For the transfer of odd-size or over-size items by means of the cart 102, it is operated with the drawer 206 in the open, i.e. retracted state as shown in FIG. 4 with the odd-size or over-size items resting in and extending upwardly from the compartment 207.

The drawer 206 has inclined side structures 209 which are configured to essentially correspond and extend in parallel to the inclined bottom surface 204 of the storage section 201.

A connecting element 210a is provided for coupling a first end of the cart 102 to a suitably configured connecting element 210b of the opposite end of an identical cart 102 to form a train of carts. As illustrated by arrow 214. At the unloading end 205, each of the shelves 202 is provided with a releasable and re-closable closing structure 212 for releasing the items supported by the respective shelves when the items are to be offloaded from the cart 102.

The storage section is preferably rotatable relative to the chassis 211 around an upright axis as shown by arc-shaped arrow 214 in FIG. 2 in order to orient the shelves and the transport direction of items within the cart relative to an external conveyor or accumulation means, such as an accumulation unit, belt loader or the like.

At least two carts 102 may be coupled or connected together to form a train of carts. A structure (not shown) for releasably locking the drawer in a selected one of a partly extracted position and a fully extracted position may be provided. For coupling the carts together to form a train of carts, the connecting element 210a, 210b may be provided, the free end of which is configured to connect the cart to another cart, the connecting element extending from the chassis 211 of the cart 102 below the drawer 206 in the direction of extraction of the drawer. The free end of the connecting element 210a, 210b is able to connect to another one of the carts when the drawer 206 is in the partly extracted position, whereas the free end of the connecting element 210a, 210b is unable to connect to the other one of the carts when the drawer 206 is in the fully extracted position. In operation, items may be selectively transported with the drawer in the fully or in the partly extracted position. When the drawer is in the partly extracted position, the first cart may be coupled to a second one of the carts by means of the connecting element with the drawer of the first cart facing the second cart. When the drawer is in the fully extracted position, items may be transported therein when the cart is not coupled to a further cart, or when the cart constitutes a first cart, which is coupled to a second cart by means of the connecting element with the drawer of the first cart facing away from the second cart. The length of the drawer, which may be as long as the cart or nearly as long as the cart may hence be fully utilized when the cart is the last one in a train of carts of is used as a stand-alone device, whereas the full length of the drawer does not occupy excessive space between neighbouring carts in a train of carts and hence does not unnecessarily limit the radius of curvature of the train.

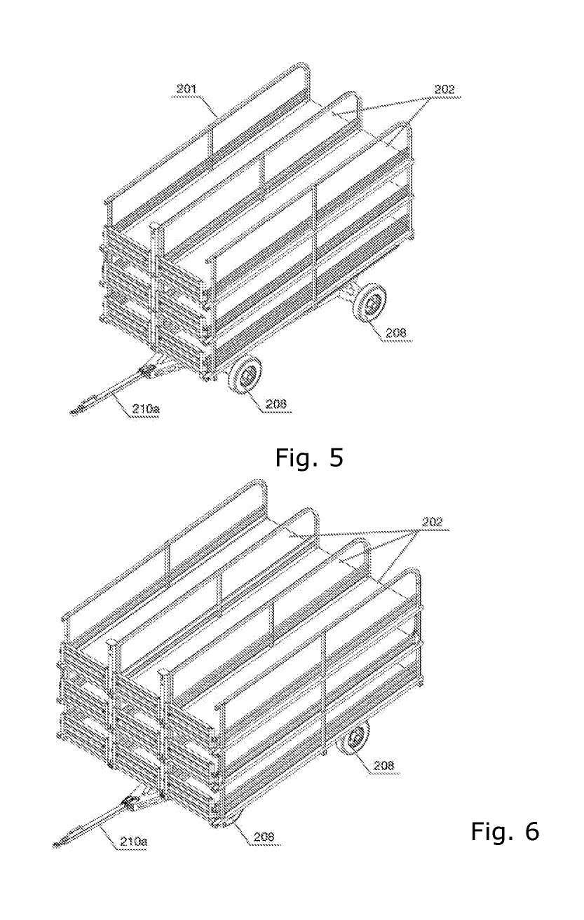

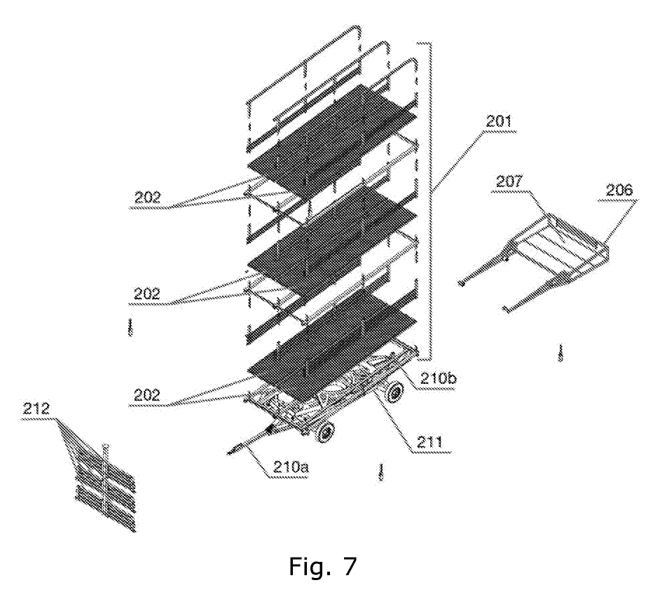

FIGS. 5 and 6 show two embodiments of the cart 102. In a first configuration shown in FIG. 5, the cart comprises two columns each comprising three rows of cart shelves 202, and in the embodiment of FIG. 6, the cart comprises three columns of cart shelves 202, each comprising three rows. In order to conveniently adapt the number of rows and columns to match any desired need, the cart may—as shown in FIG. 7—be assembled from a number of modules which may be configured and sized to match the need as given by a particular application.

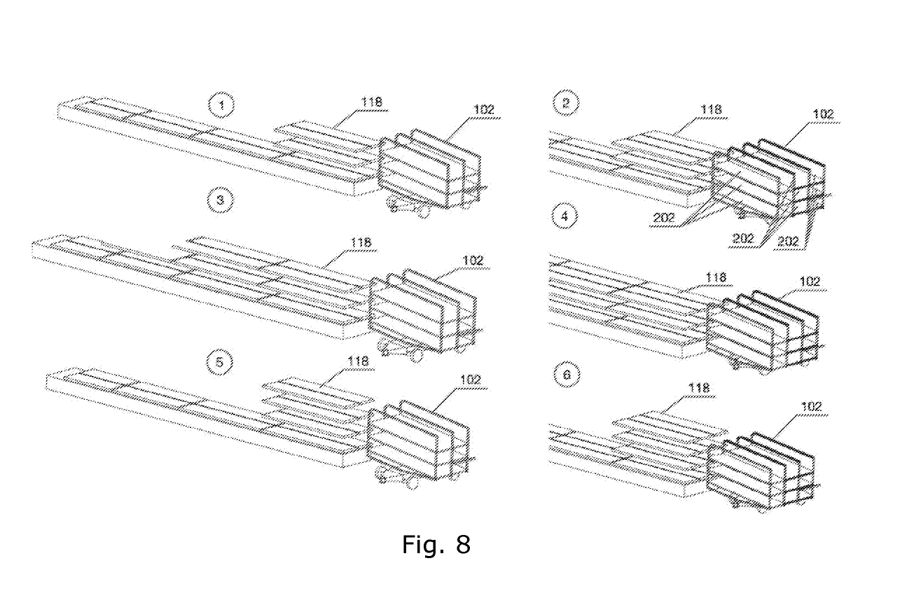

FIG. 8 shows the cart in a parking position in front of an accumulation unit 118 or other item storage or conveyor facility of loading of items onto the cart. The system of FIG. 8 embodies the third aspect of the invention, with the accumulation 118 constituting a matrix-pattern conveyor system matching the matrix patterns of the cart.

1-15. (canceled)

16. A cart for transport and storage of items, comprising:
a chassis comprising a plurality of wheels;
a storage section comprising at least one shelf;
wherein:
a drawer below the storage section, the drawer comprising a compartment which is inaccessible when the drawer is in a closed state, in which the drawer is overlapped by a bottom portion of the storage section, and wherein the compartment is accessible when the drawer is in an open state, in which the drawer is extracted from and extends beyond the bottom portion of the storage section.

17. A cart according to claim 16, wherein the storage section and the at least one shelf are sized and configured to accommodate items having a dimension or volume not exceeding a first maximum dimension or a first maximum volume, and wherein the compartment is sized and configured to accommodate odd-size items having a dimension or volume exceeding the first maximum dimension or the first maximum volume.

18. A cart according to claim 16, comprising structure for releasably locking the drawer in a selected one of a partly extracted position and a fully extracted position.

19. A cart according to claim 16, further comprising a connecting element, the free end of which is configured to connect the cart to another cart, the connecting element extending from the chassis of the cart below the drawer in the direction of extraction of the drawer, wherein the free end of the connecting element extends beyond the drawer when the drawer is in an extracted position.

20. A cart according to claim 18, wherein the free end of the connecting element extends beyond the drawer when the drawer in the partly extracted position, and wherein the free end of the connecting element does not extend beyond the drawer when the drawer is in the fully extracted position.

21. A cart according to claim 16, wherein the bottom portion of the storage section comprises a planer bottom surface, which is inclined relative to horizontal, and wherein the drawer comprises correspondingly tapering side structures.

22. A cart according to claim 16, wherein the at least one shelf comprises a plurality of shelves arranged in rows and columns.

23. A cart according to claim 16, wherein each of said shelves is inclined relative to horizontal, so as to thereby define an upper end and a lower end, the upper end of each shelf being arranged at a loading end of the cart, and the lower end of each shelf being arranged at an unloading end of the cart.

24. A method for transport and storage of items by means of at least one cart comprising
a chassis comprising a plurality of wheels;
a storage section comprising at least one shelf;
a drawer below the storage section, the drawer comprising a compartment which is inaccessible when the drawer is in a closed state, in which the drawer is overlapped by a bottom portion of the storage section, and wherein the compartment is accessible when the drawer is in an open state, in which the drawer is extracted from and extends beyond the bottom portion of the storage section;
said method comprising the steps of:
loading a first group of said items onto the at least one shelf of the storage section;
loading at least one further item into the compartment of the drawer when the drawer is in the open state, said at least one further item being sized and shaped so that it does not fit into the compartment when the drawer is in the closed state; and
transporting the items by means of said cart while the drawer remains in the open state.

25. A method according to claim 24, wherein said first group of items comprises air passenger luggage, and wherein said at least one further item comprises an odd-size air passenger luggage.

26. A method according to claim 24, wherein the items are transported by means of said cart from an aircraft site to a luggage conveyor site of an airport, or from a luggage sorting conveyor site of the airport to the aircraft site.

27. A method according to claim 24, wherein the at least one cart comprises at least two identical carts, each of which comprises:
a structure for releasably locking the drawer in a selected one of a partly extracted position and a fully extracted position, and
a connecting element, the free end of which is configured to connect the cart to another cart, the connecting element extending from the chassis of the cart below the drawer in the direction of extraction of the drawer, wherein the free end of the connecting element is able to connect to another one of the carts when the drawer is in the partly extracted position, and wherein the free end of the connecting element is unable to connect to the other one of the carts when the drawer is in the fully extracted position; the method comprising the step of selectively:
transporting said at least one further item in the compartment of the drawer of a first one of the carts, when the drawer is in the partly extracted position, and while the first cart is coupled to a second one of the carts by means of the connecting element with the drawer of the first cart facing the second cart;
transporting said at least one further item in the compartment of the drawer of a first one of the carts, when the drawer is in the fully extracted position, and while
the first cart is not coupled to the second one of the carts or
the first cart is coupled to the second one of the carts by means of the connecting element with the drawer of the first cart facing away from the second cart.

28. A system comprising at least one cart and an accumulation unit for loading items on to the cart or for accepting items offloaded from the at least one cart, the at least one cart comprising:
a chassis comprising a plurality of wheels;
a storage section comprising at a plurality of shelves arranged in rows and/or columns to form a first matrix pattern;
wherein
the accumulation unit comprises a plurality of shelves arranged in rows and/or columns forming a second matrix pattern, and in that
each one of the shelves the first and second matrix patterns forms a continuation of one of the shelves of the other one of the first and second patterns when the at least one cart is in a predetermined parking position relative to the accumulation unit.

29. A system according to claim 28, wherein the at least one cart is a cart for transport and storage of items, comprising:
a chassis comprising a plurality of wheels;
a storage section comprising at least one shelf;
wherein:
a drawer below the storage section, the drawer comprising a compartment which is inaccessible when the drawer is in a closed state, in which the drawer is overlapped by a bottom portion of the storage section, and wherein the compartment is accessible when the drawer is in an open state, in which the drawer is extracted from and extends beyond the bottom portion of the storage section.

30. Use of a system according to claim 28 for transport and accumulation of airport luggage, parcels or dairy products.
